(19) United States
(12) Patent Application Publication
(10) Pub. No.: US 2025/0182919 A1
(43) Pub. Date: Jun. 5, 2025

(54) CHLORIDE BASED VOLATILITY FOR THE RECOVERY OF URANIUM FROM NUCLEAR FUEL SALT

(71) Applicant: TerraPower, LLC, Bellevue, WA (US)

(72) Inventors: Hilary Fitzgerald, North Bend, WA (US); Aaron Unger, Henderson, NV (US); Sayandev Chatterjee, Redmond, WA (US); Katie McBride, Lake Stevens, WA (US); Perry Motsegood, Sammamish, WA (US); SeungMin Lee, Everett, WA (US); Jeffrey F. Latkowski, Mercer Island, WA (US)

(21) Appl. No.: 18/907,145

(22) Filed: Oct. 4, 2024

Related U.S. Application Data
(60) Provisional application No. 63/605,995, filed on Dec. 4, 2023.

(51) Int. Cl. G21C 19/50

(52) U.S. Cl. CPC G21C 19/50

(57) ABSTRACT

Disclosed herein are methods and systems for the recovery of uranium from used fuel salts using nonaqueous chemistry without electrometallurgy techniques. The used fuel salts are maintained in a molten state in a chlorination chamber, and are then chlorinated for a period of time sufficient to convert at least some UCl₃ into a different uranium chloride, thereby generating a uranium-containing gas phase. The uranium-containing gas phase is separated from the resulting residue, and is condensed for collection.

### CROSS-REFERENCE TO RELATED APPLICATIONS

This application claims the benefit of U.S. Provisional Patent Application No. 63/605,995, filed Dec. 4, 2023, which is incorporated by reference herein in its entirety.

### STATEMENT OF FEDERALLY SPONSORED RESEARCH OR DEVELOPMENT

The new inventions in this application were made with government support under the ARPA-E ONWARDS program Award No. DE-AR0001612. The government has certain rights in these inventions.

### INTRODUCTION

The utilization of molten chloride nuclear fuels, or simply molten fuels, in a nuclear reactor to produce power provides significant advantages as compared to solid fuels. For instance, molten nuclear fuel reactors generally provide higher power densities compared to solid fuel reactors, while at the same time having reduced fuel costs due to the relatively high cost of solid fuel fabrication.

In nuclear reactors using molten fuel, the majority of the spent or used fuel salt (UFS) is composed of uranium. Recovery/reuse of this uranium, enabled by a reduced-cost approach with favorable non-proliferation and safeguards characteristics, could reduce requirements for permanent disposal and be of great interest for the nuclear industry.

Chloride Based Volatility for the Recovery of Uranium from Nuclear Fuel Salt

A novel approach is proposed herein for the selective removal of uranium from UFS by exploiting the unique physical properties of UCl₄ and other uranium chlorides relative to fission products and other materials present in UFS.

Disclosed herein are methods and systems for the recovery of uranium from used fuel salts using nonaqueous chemistry without electrometallurgy techniques. The used fuel salts are maintained in a molten state in a chlorination chamber and are then chlorinated for a period of time sufficient to convert at least some UCl₃ into a different uranium chloride. This results in generation of a uranium-containing gas phase that is separated from the resulting residue, and that may be then condensed for collection.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The figures, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure.

FIG. 1 illustrates a simple embodiment of a method for the chloride-based volatility (CBV) separation of uranium from UFS.

FIG. 2, for example, illustrates a ternary phase diagram calculated for UCl₃—UCl₄—NaCl fuel salts based thermodynamic models.

FIG. 3 illustrates an embodiment of a CBV separation system based on the method described in FIG. 1.

FIG. 4 illustrates an embodiment of a larger waste handling process showing how the CBV method of FIG. 1 can be incorporated into a UFS handling and disposal system.

FIG. 5 illustrates an example experimental apparatus used for separating uranium from a surrogate UFS material.

FIG. 6 illustrates the preliminary results of a DSC/TGA analysis of samples taken of the salt matrix.

FIG. 7 illustrates a diagram of an example experimental apparatus.

### DETAILED DESCRIPTION

Before the uranium removal systems and methods are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments of the uranium removal systems and methods only and is not intended to be limiting. It must be noted that, as used in this specification, the singular forms “a,” “an,” and “the” include plural referents unless the context clearly dictates otherwise. Thus, for example, reference to “a lithium hydroxide” is not to be taken as quantitatively or source limiting, reference to “a step” or “an operation” may include multiple steps or operations, reference to “producing” or “products” of a reaction should not be taken to be all of the products of a reaction, and reference to “reacting” may include reference to one or more of such reaction steps. As such, the step of reacting can include multiple or repeated reaction of similar materials to produce identified reaction products.

Unless defined otherwise, all technical and scientific terms used herein have the same meaning as those commonly understood to one of ordinary skill in the art to which this technology pertains.

For the purposes of this application the following terms shall have the following meanings:

Other than in the operating examples, or where otherwise indicated, all numbers expressing quantities of ingredients or reaction conditions used herein should be understood as modified in all instances by the term “about.” The term “about” when used herein in connection with numerical values means ±20% and with percentages means ±4%. Note that all percentages (%) are by weight unless otherwise specified.

As used herein, the term “comprising” refers to a composition, compound, formulation, or method that is inclusive and does not exclude additional elements or method steps.

As used herein, the term “consisting of” refers to a compound, composition, formulation, or method that excludes the presence of any additional component or method steps.

As used herein, the term “consisting essentially of” refers to a composition, compound, formulation or method that is inclusive of additional elements or method steps that do not materially affect the characteristic(s) of the composition, compound, formulation or method.

The utilization of molten chloride nuclear fuels, or simply molten fuels, in a nuclear reactor to produce power provides significant advantages as compared to solid fuels. For instance, molten nuclear fuel reactors generally provide higher power densities compared to solid fuel reactors, while at the same time having reduced fuel costs due to the relatively high cost of solid fuel fabrication.

However, the issues confronted in recovering uranium from a used or spent nuclear fuel salt are complex and the methods used to recover uranium from more traditional uranium oxide fuel are not applicable. Ideally, the bulk uranium would be separated from the fission products, without greatly increasing the volume, as is characteristic of many of the existing recovery methods. Primary factors hindering such a process include: a) the chemical similarity of uranium and plutonium, b) the potential for nuclear proliferation if the plutonium is purified from the UFS as a specific process step, and c) the intense radiation from minor actinides. To address these issues, a novel approach is proposed herein for the selective removal of uranium from UFS by exploiting the unique physical properties of UCl₄ and other uranium chlorides relative to fission products and other materials present in UFS.

This disclosure presents a method for the recovery of uranium from used fuel salts using nonaqueous chemistry without electrometallurgy techniques, such as pyroprocessing. The methods and systems use chloride-based volatility (CBV) as the basis for uranium recovery from UFS. Due to the low volatility of trivalent f-element chlorides, e.g. plutonium, lanthanide and other fission products (FPs), a separation occurs based on the temperature at which the fission products (e.g., uranium (IV) chloride (UCl₄)) become volatile chlorides. Thus, a CBV method may be uniquely suited for uranium separation from UNF. Note that the CBV separation process is described below in terms of separating uranium from UFSs containing uranium chlorides. However, the CBV process is equally applicable to other fuel salts including uranium fluoride salts (e.g., UF₆), uranium bromide salts (e.g., UBr₃) and mixtures thereof (e.g., UCl₃F). The CBV process could also be adapted to the processing of UFSs containing uranium salts. Thus, while presented in the terms of processing uranium chloride UFSs, the reader should understand that the process equally may be applied to any uranium fuel salt containing material, generally, regardless of the salt type and regardless of whether the material was ever used in a nuclear reactor.

Metal chlorides have a wide range of sublimation and boiling points that lend to a simple, temperature-based separation. The relatively low sublimation range for UCl₄, 500° C.-650° C., which is not within 50° C. of any known or anticipated FPs, illustrates the potential to isolate the bulk uranium from UFS, see Table 1 for a list of selected FPs along with their boiling or sublimation points. The chlorination environment coupled with the thermodynamic instability of Pu(IV) will drive plutonium to the trivalent ion as PuCl₃, which has a significantly higher boiling point of 1767° C., well beyond the parameters of the process. The high boiling point of PuCl₃ is in line with other FPs such as ²⁴¹Am, all of the rare earth, alkaline earth, and alkali elements, leaving a complex mixture behind. This residual mixture will produce significant radiologic activity due to the ²⁴¹Am isotope, preventing opportunities for proliferation. Further, several main group and transition metal FPs boil significantly below UCl₄, allowing for an additional separation.

TABLE 1
Boiling or Sublimation Temperature for Selected Metal Chlorides at 1 atm

| Compound | MoCl₅ | UCl₆ | UCl₅ | UCl₄ | AmCl₃ | UCl₃ | GdCl₃ | PuCl₃ | PuCl₄ |
|---|---|---|---|---|---|---|---|---|---|
| b.p./sub | 268 | 372 | 527 | 500-650 | 850 | 1410 | 1580 | 1767 | 700-800 |
| (° C.) | | | | (sub) | | | | | (sub) |

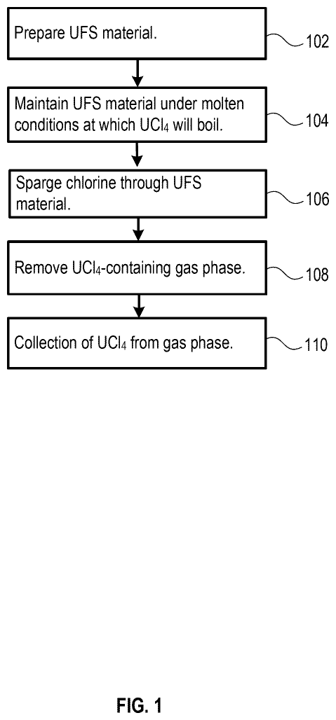

FIG. 1 illustrates a simple embodiment of a method 100 for the CBV separation of uranium from UFS. In the method 100 as shown, the UFS containing the uranium salt (e.g., UCl₃) is transported, prepared, and placed in a chlorination chamber in a preparation operation 102. In an embodiment, transportation may include removing the UFS from a reactor or storage facility. The preparation operation 102 may also include pulverization or crushing of solid UFS into a powder or other aggregate form to assist in transportation or to perform a preliminary physical separation (not shown) of impurities from the UFS. The UFS is then placed in the chlorination chamber, such as a closed vessel.

In embodiments, the UFS material subjected to the chlorination and UCl₄ sublimation operation 104 is at least 50% by weight uranium salt, and can be at least 75% uranium salt, at least 80% uranium salt, at least 90% uranium salt and even at least 95% uranium salt. The remaining non-uranium salt material in the UFS can be considered impurities and include the other materials such as FPs and cladding materials as described above. These impurities may be up to 50% by weight of the UFS such as UFS containing at least 0.1%, at least 0.5%, at least 1.0%, at least 5%, at least 10% and at least 25% by weight impurities.

In an alternative embodiment, the UFS may be in a nuclear reactor and the chlorination chamber may be the same chamber that held the UFS during regular operation of the reactor. This embodiment reduces the amount of handling of the UFS.

The temperature and pressure of the chlorination chamber then controlled to maintain the UFS in a molten state and within a range of temperatures and pressures under which a) the UFS remains molten and b) the uranium chlorination products (e.g., UCl₄, UCl₅, UCl₆ and other higher order uranium chlorides) are a gas and the new uranium chloride compounds will boil out of the UFS. This operation 104 may be referred to as maintaining the UFS under conditions that generate a uranium chloride-containing gas phase. In some examples, agitation or mixing may also be performed during operations 102 and/or 104 to improve reaction kinetics and/or heat transfer. In such examples, the chlorination chamber (or other vessel utilized for operations 102 and/or 104) may be provided with mixing paddles, injectors for gas injection, flow circulation nozzles, or any other component for providing agitation to the components in the chlorination chamber (or other vessel as noted).

In some examples, during maintaining operation 104, the UFS may be maintained at a temperature between about 550° C. and about 900° C. In some examples, during maintaining operation 104, the UFS may be maintained at a temperature between about 550° C. and about 900° C. In some examples, during maintaining operation 104, the UFS may be maintained at a temperature between about 450° C. and about 900° C. In some examples, during maintaining operation 104, the UFS may be maintained at a temperature between about 500° C. and about 900° C. In some examples, during maintaining operation 104, the UFS may be maintained at a temperature between about 550° C. and about 800° C. In some examples, during maintaining operation 104, the UFS may be maintained at a temperature between about 550° C. and about 700° C. In some examples, during maintaining operation 104, the UFS may be maintained at a temperature between about 500° C. and about 700° C. In some examples, during maintaining operation 104, the UFS may be maintained at a temperature between about 550° C. and about 650° C. In some examples, during maintaining operation 104, the UFS may be maintained at a temperature of about 500° C. In some examples, during maintaining operation 104, the UFS may be maintained at a temperature of about 550° C. In some examples, during maintaining operation 104, the UFS may be maintained at a temperature of about 600° C. In some examples, during maintaining operation 104, the UFS may be maintained at a temperature of about 650° C. In some examples, during maintaining operation 104, the UFS may be maintained at a temperature of about 700° C. In some examples, during maintaining operation 104, the UFS may be maintained at a temperature greater than about 500° C. In some examples, during maintaining operation 104, the UFS may be maintained at a temperature greater than about 550° C. In some examples, during maintaining operation 104, the UFS may be maintained at a temperature greater than about 600° C. In some examples, during maintaining operation 104, the UFS may be maintained at a temperature less than about 600° C. In some examples, during maintaining operation 104, the UFS may be maintained at a temperature less than about 650° C. In some examples, during maintaining operation 104, the UFS may be maintained at a temperature less than about 700° C. In some examples, during maintaining operation 104, the UFS may be maintained at a temperature less than about 900° C.

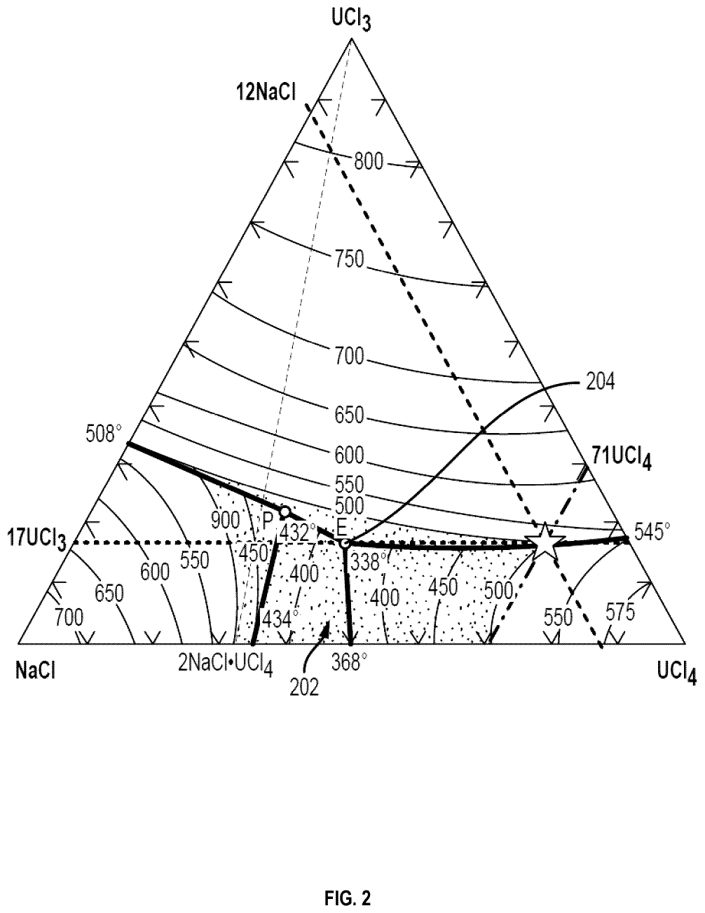

FIG. 2, for example, illustrates a ternary phase diagram calculated for UCl₃—UCl₄—NaCl fuel salts based thermodynamic models. The diagram 200 shows the expected melting temperature for any mixture of UCl₃—UCl₄—NaCl at about 1 atm. As an example of how to read the diagram, mixtures having a melting point less than 500° C. are illustrated in the shaded region 202 of the diagram 200. The eutectic point 204 has a melt temperature of 338° C. and a composition of 17UCl₃-40.5UCl₄-42.5NaCl (i.e., 17 mol % UCl₃, 40.5 mol % UCl₄ and 42.5 mol % NaCl). The shaded region 202 indicates a melting point envelope of 500° C. Moving to the far-right of this envelope 202 provides an embodiment, 17UCl₃-71UCl₄-12NaCl, but note that many possible compositions exist within the envelope 202 as embodiments of fuel salt mixtures having a melting point at or below 500° C.

From the diagram 200, the axis between NaCl and UCl₃ show the melting points of all NaCl—UCl₃ mixtures from 100% NaCl to 100% UCl₃. Thus, if the composition is known the melting point can be easily determined. However, if the composition is not known for certain, the diagram 200 indicates that maintaining the UFS at or above the melting point of pure UCl₃, 837° C. will ensure that a NaCl—UCl₃ UFS is molten and will also ensure that any UCl₄ will boil off. Note that from Table 1, above, higher order uranium chlorides UCl₅ and UCl₆ much lower than that of UCl₄ and any such higher order uranium chlorides formed by the chlorination 106 will also quickly boil out of the molten salt matrix.

Referring again to method 100, after the salt is placed into the molten state as described above, a chlorinating operation 106 is then performed which exposes the molten UFS to Cl. In the embodiment shown, this is done by sparging the UFS with pure Cl₂ gas. In an alternative embodiment, a combination of Ar and Cl₂ gas could be used. In yet another embodiment, Cl₂ gas could be mixed with any number of other noble or inert gases. In yet another embodiment, the Cl may be provided in some other form than Cl₂ gas, such as via HCl, CCl₄, or another appropriate Cl-containing compound, which may be utilized in chlorinating operation 106 as pure compounds, mixtures of compounds, and/or mixed with one or more noble or inert gasses. Specific examples described herein, including referring to the Figures, may describe an Ar/Cl₂ chlorinating environment as a particular example for conciseness; however, the technology may also utilize/include other appropriate chlorinating environments (e.g. including other appropriate Cl-containing compounds and/or other noble/inert gasses) in accordance with the disclosures herein.

The chlorination operation 106 converts at least some UCl₃ in the UFS to UCl₄ or other higher order chlorides of uranium. These higher order chlorides will boil out of the molten salt as a uranium-containing gas.

A removal operation 108 is then performed in which the uranium-containing gas is removed. This may include moving the gas to a different part of the vessel or moving the gas into a separate collection vessel.

Finally, a collection operation 110 may be performed where the uranium compounds from the uranium-containing gas, e.g., UCl₄, are condensed.

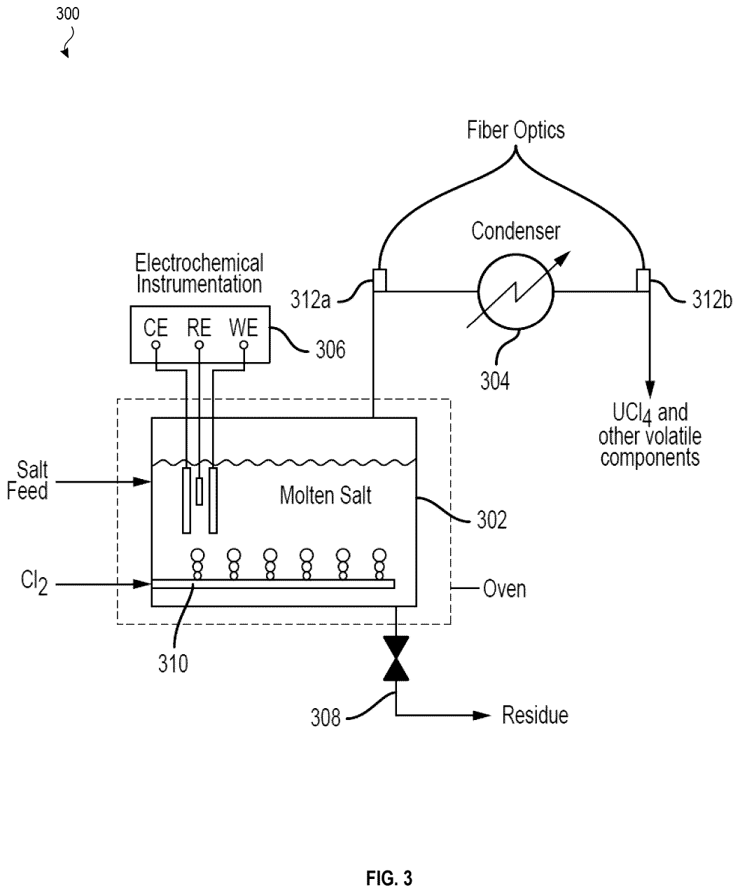

FIG. 3 illustrates an embodiment of a CBV separation system 300 based on the method described in FIG. 1. In the embodiment shown, prepared UFS is placed in the chlorination chamber 302. A chlorination feature 310, for example, a sparger, provides a Cl source to the chlorination chamber 302 for chlorination of the molten UFS. In some examples, Cl₂ or other chlorinating gas as described above is sparged through the molten UFS. The pressure and temperature of the chlorination chamber are controlled to maintain the UFS under conditions at which UCl₄ and/or other higher order uranium chlorides will boil out of the UFS. Over time, the UCl₃ will react with the Cl to create gaseous UCl₄ and other higher order uranium chlorides.

The uranium-containing gas mixture is then transferred from the chlorination chamber 302 to a collection chamber through a condenser 304. It should be noted that this gas mixture will be referred to as the uranium-containing gas mixture for the sake of convenience even though the mixture may be much more complex; in reality, UFS can encompass a wide variety of materials include FPs the resulting gas mixture exiting the chlorination chamber 302 may include many different compounds not otherwise discussed herein. In the condenser 304, temperature or pressure may be slightly reduced from that of the chlorination chamber 302 to induce the deposition of the uranium products into a solid phase.

Even if all the uranium is recovered in this manner, at least some residue will be remain. This will include any other chloride salt constituents such as NaCl, as well as any non-volatile FPs. The residue 308 can be physically removed from the chamber 302 and either disposed of as is or passed through additional separations, such as to recover valuable FPs or simply to reduce the amount of material by recovering the NaCl or other base salts.

FIG. 3 further illustrates electrochemical instrumentation 306 (e.g. one or more electrochemical instruments) that monitors one or more of the electrochemical parameters (for example, within chlorination chamber 302) to determine in real-time the extent of the chlorination and volatilization achieved at any point in the process. Further illustrated are one or more fiber optic chemical sensors (FOCS) 312 configured to measure volatile concentrations. In the particular example illustrated, one FOCS 312a is located upstream of the condenser 304 and another FOCS 312b is located downstream of the condenser 304, however, different numbers and placements of FOCS within the system may be contemplated.

In the embodiment shown in FIG. 3, the different chambers may be physically different vessels connected via valves and piping or may be different locations in within a single continuous vessel. In a single vessel embodiment, transferring of gas from one chamber to another may be achieved by maintain a flow of gas through the single vessel. If physically different vessels are used for each chamber, the CBV separation process may be done either as a batch process or a continuous process or any combination of the two. Each chamber may be independently temperature controlled and may be provided with independent heating and/or cooling systems. As long as the desired conditions are maintained, any method and equipment for controlling the conditions in the different chambers may be utilized.

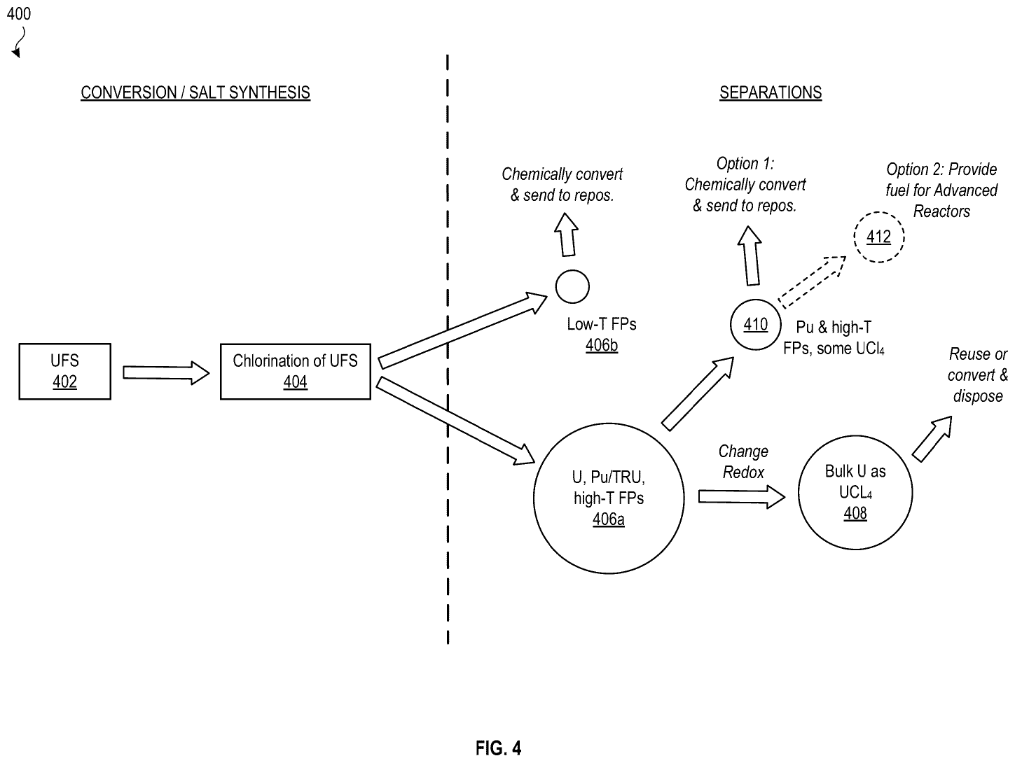

FIG. 4 illustrates an embodiment of a larger waste handling process 400 showing how the CBV method of FIG. 1 can be incorporated into a UFS handling and disposal system. The CBV separation method is particularly suitable when considering the larger picture of UFS disposal where, not only can it be used to recover valuable uranium from the UFS, the CBV separation method described herein has the added benefit over other methods of reducing the overall mass of the waste UFS thereby reducing disposal costs.

As shown in FIG. 4, UFS 402 is chlorinated in a conversion step 404 to the higher order chloride salt form as described above. Multiple separations and disposal steps then follow based on the material, to separate the constituents of the product mixture(s), which may include a mixture of uranium, high-temperature FPs, and other compounds 406a, and a mixture of low temperature FPs 406b. As mentioned above, significant value lies in the uranium. The removed uranium chlorides 408 can be converted chemically back to UCl₃ (a feed for some molten salt reactor designs) or to uranium metal from which new nuclear fuel could be made.

Plutonium and high boiling temperature fission products 410, which remain with the UFS after the chlorination and sublimation operation, could be sent to a repository (refer to Option 1) for disposal or, alternatively, could be used as a starter fuel 412 for some advanced reactor designs (refer to Option 2). Furthermore, recovery of plutonium can be done as part of the processing of a co-waste stream laden with noble metals, rare-earth fission products, and minor actinides, which is beneficial for non-proliferation goals.

As noted above, a majority of the mass of UFS is typically uranium chloride. Thus, using the CBV separation method to selectively remove the uranium from the rest of the UFS will drastically reduce the mass of the remaining UFS that must be disposed of. This is very beneficial beyond the normal cost savings in the recovery of the uranium when one considers that the space in a disposal repository is finite and not necessarily subject to normal economic pressures.

### EXAMPLES

The first three (3) experiments utilized the salt matrix containing: 43.3 mol % LiCl: 36.6 mol % NaCl and 20.1 mol % UCl₃. This matrix was chosen due to its anticipated low melting point and electrochemical window with no or limited overlaps with uranium and other species of interest.

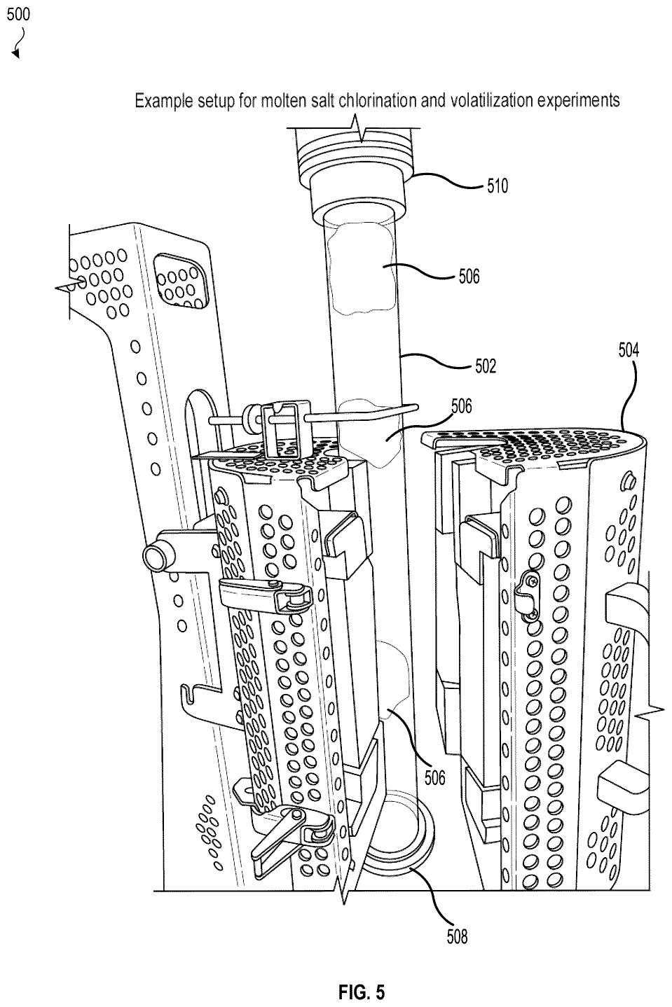

FIG. 5 is diagram of an example experimental apparatus 500 for carrying out the experiments. The Li—Na—U salt mixture was weighed out, thoroughly mixed and placed onto the top of the frit in the working tube 502. Quartz wool “plugs” 506 are placed within the working tube and used to prevent any UCl₅ moving beyond the end of the tube. The quartz wool plugs 506 also diffuse the gas stream throughout the working tube 502. The gas inlet is through the bottom 508 of the working tube 502 and gas outlet is through the top 510 of the working tube 502 once in the vertical orientation. A heater/furnace 504 encloses at least a portion of working tube 502, and may be utilized to control a heated temperature of the working tube 502 and its contents.

Once leak checks are performed, Ar flow is started, around 70 mL/min and heating at least 50 degrees beyond the melting point may begin. A temperature range of from 550-900° C. was explored during these experiments. Once the salt has melted, an equilibration period of 1 hour is allowed to ensure that the salt is homogenous and completely melted prior to beginning the chlorination stage. After equilibration period, chlorination begins with the introduction of chlorine gas at 70 mL/min. After approximately 15 minutes of chlorination the chlorine cylinder is closed and then the lines purged with Ar for another 15 minutes. The chlorine and purging cycle is repeated until the majority of the uranium has volatilized out of the salt matrix. The experiments were terminated based a visual inspection of the changes in the starting material and the length of the experiments averaged around 4 hours of total chlorination (i.e., flowing Cl₂) time.

Table 2 illustrates the yield obtained from the first three experiments.

TABLE 2
Molten Salt Experimental Results

| MS Experiment Number | Product | % Yield |
|---|---|---|
| 1 | Na₂UCl₆ (non-volatile phase) | 7 |
| 2 | Li₂UCl₆ | 26.9 |
| 3 | Li₂UCl₆ | <1 |

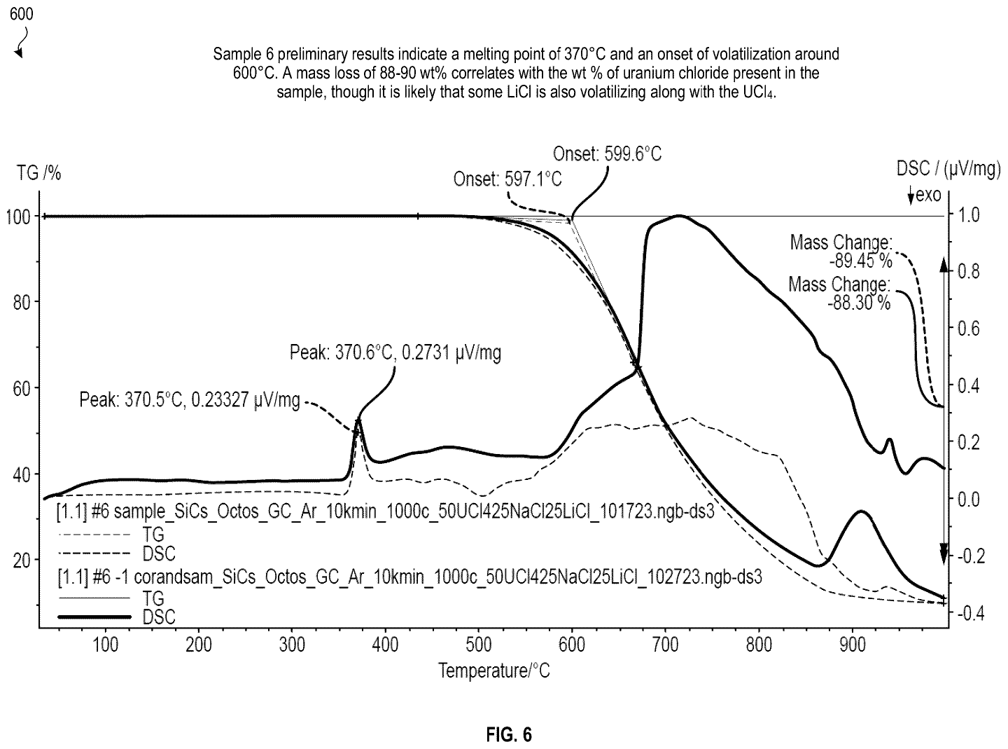

FIG. 6 illustrates the preliminary results of a DSC/TGA analysis of samples taken of the salt matrix, depicted as a graph 600. Due to limited volatilization that has been seen in preliminary testing, samples were prepared for DSC/TGA analysis, the results of which are shown in Table 3. These results indicate a melting point of 370° C. of the salt matrix and an onset of volatilization around 600° C. A mass loss of 88% to 90 wt % correlates with the wt % of all the uranium chloride present in the sample indicating about a 100% removal of uranium. However, the collected evaporation product has not yet been tested and it is possible that some LiCl is also volatilizing along with the UCl₄. Preliminary results indicate that an increased concentration of UCl₃ may be required to increase the volatilization of the salt matrix, 50 mol % UCl₃ and equimolar NaCl and LiCl. The melting point also appears to remain low enough to maintain a molten state during the volatilization of the majority of uranium.

TABLE 3
DSC/TGA sample components list

| Sample | UCl₄ | NaCl | LiCl | KCl |
|---|---|---|---|---|
| # | (mol %) | (mol %) | (mol %) | (mol %) |
| 1 | 5 | 47.5 | | 47.5 |
| 2 | 33 | 33.5 | | 33.5 |
| 3 | 50 | 25 | | 25 |
| 4 | 5 | 47.5 | 47.5 | |
| 5 | 33 | 33.5 | 33.5 | |
| 6 | 50 | 25 | 25 | |

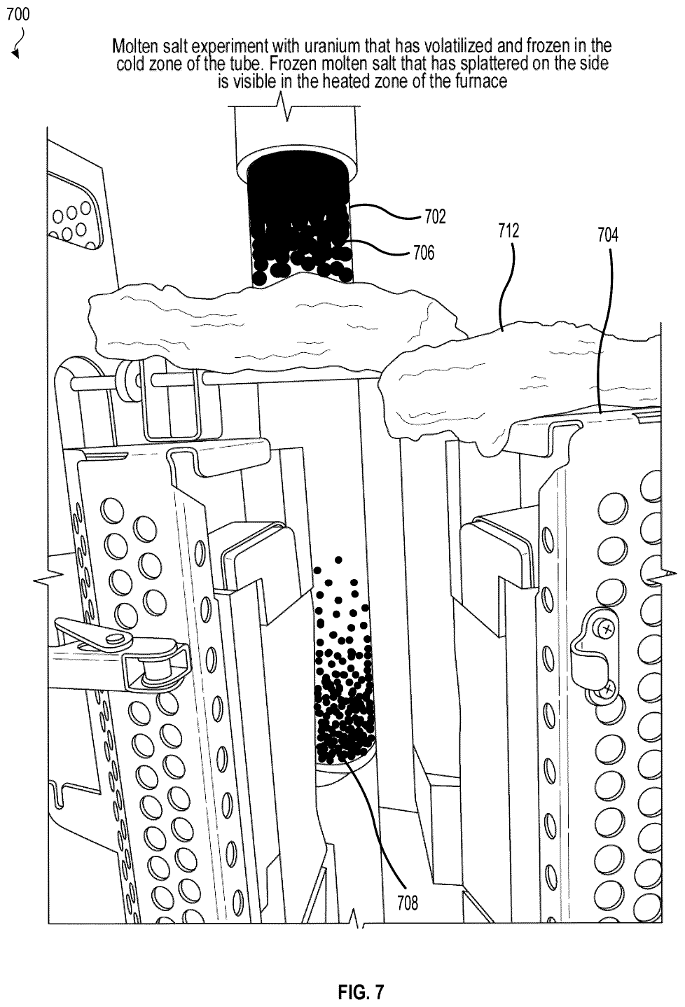

FIG. 7 is a diagram of the experimental apparatus, illustrating an example 700 during one of the experiments. Within the upper end of the working tube 702, in the cold zone outside of the heater 704, uranium 706 has volatilized and frozen within the working tube 502. Frozen molten salt 708 has splattered onto the sidewall of the working tube 702 is visible within the heated zone, in the area of the working tube exposed to the heat of the furnace/heater 704. In the particular example illustrated, insulation 712 is placed on at least one external surface of the heater 704.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained.

Notwithstanding that the numerical ranges and parameters setting forth the broad scope of the technology are approximations, the numerical values set forth in the specific examples are reported as precisely as possible. Any numerical value, however, inherently contain certain errors necessarily resulting from the standard deviation found in their respective testing measurements.

It will be clear that the systems and methods described herein are well adapted to attain the ends and advantages mentioned as well as those inherent therein. Those skilled in the art will recognize that the methods and systems within this specification may be implemented in many manners and as such are not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope contemplated by the present disclosure. For example, a number of process optimization changes could be done depending on the scale throughput of a CBV separation system such using a mixed gas (e.g., a mixture of Cl₂ and Ar) to better control the speed of chlorination reaction, the resulting specie of the reaction (e.g., increase the relative amount UCl₄ as a product over UCl₆ in the uranium-containing gas) or alter the amount of agitation in the salt without changing the amount of chlorine being injected over time. Likewise, including filters in the gas removal system to prevent physical carry or splashing over of compounds could be beneficial from the examples and tests performed. Numerous other changes may be made which will readily suggest themselves to those skilled in the art and which are encompassed in the spirit of the disclosure.

Illustrative examples of the systems and methods described herein are provided below. An embodiment of the system or method described herein may include any one or more, and any combination of, the numbered clauses described below:

1. A method for separating uranium from a material containing uranium trichloride (UCl₃) and at least 1% by weight other material, the method comprising: maintaining the material containing the UCl₃ in a molten state; chlorinating the material for a period of time sufficient to convert at least some UCl₃ into a different uranium chloride, thereby generating a uranium-containing gas phase; and collecting the uranium-containing gas phase.

2. The method of clause 1, wherein material is a mixture of UCl₃ and one or more other chloride salts.

3. The method of clause 2, wherein the one or more other chloride salts comprise at least a binary salt of UCl₃ and at least one additional chloride salt.

4. The method of clause 2, wherein the one or more other chloride salts comprise at least a ternary salt of UCl₃ and one additional chloride salt.

5. The method of any of clauses 1-4, wherein the material is a used nuclear fuel salt comprising at least one fission product of uranium.

6. The method of any of clauses 1-5, wherein the material is contained within a vessel during the maintaining, chlorinating, and collecting steps.

7. The method of clause 6, wherein the vessel is configured to act as a reactor core and is part of a nuclear reactor.

8. The method of any of clauses 1-7, wherein the maintaining step holds the material at a temperature and pressure at which the material is molten and the different uranium chloride will boil.

9. The method of clause 8, wherein the temperature is between about 550° C. and about 900° C. and the pressure is about 1 atm.

10. The method of clause 9, wherein the temperature is about 600° C.

11. The method of any of clauses 1-10, wherein the chlorinating step comprises exposing the material to chlorine gas.

12. The method of any of clauses 1-11, wherein the chlorinating step comprises sparging chlorine gas and at least one of: a noble gas or an inert gas through the material.

13. The method of any of clauses 1-12, wherein the chlorinating step comprises exposing the material to a combination of argon and chlorine gas.

14. The method of any of clauses 1-13, wherein the chlorinating step comprises exposing the material to hydrochloric acid.

15. The method of any of clauses 1-14, further comprising condensing the uranium-containing gas phase.

16. The method of any of clauses 1-15, further comprising agitating the molten material.

17. A system, comprising: a chlorination chamber configured to hold a molten material containing uranium trichloride (UCl₃), the chlorination chamber comprising: a chlorination feature; a uranium-containing gas phase outlet; and a residue outlet; and a condenser configured to receive the uranium-containing gas phase.

18. The system of clause 17, wherein the chlorination feature is configured to sparge chlorine gas through the mixture.

19. The system of any of clauses 17-18, wherein the chlorination chamber is maintained at a temperature of between about 550° C. and about 900° C.

20. The system of any of clauses 17-19, wherein the chlorination chamber is maintained at a temperature of about 600° C.

21. The system of any of clauses 17-20, further comprising at least one fiber optical chemical sensor adjacent to the condenser.

22. The system of any of clauses 17-21, further comprising at least one electrochemical instrument configured to monitor one or more electrochemical parameters within the chlorination chamber.

23. The system of any of clauses 17-22, wherein material is a mixture of UCl₃ and one or more other chloride salts.

24. The system of any of clauses 17-23, wherein the material is a used nuclear fuel salt containing fission products.

25. The system of any of clauses 17-24, wherein the chlorination chamber is configured to act as a reactor core and is part of a nuclear reactor.

What is claimed is:

1. A method for separating uranium from a material containing uranium trichloride (UCl₃) and at least 1% by weight other material, the method comprising:
maintaining the material containing the UCl₃ in a molten state;
chlorinating the material for a period of time sufficient to convert at least some UCl₃ into a different uranium chloride, thereby generating a uranium-containing gas phase; and
collecting the uranium-containing gas phase.

2. The method of claim 1, wherein material is a mixture of UCl₃ and one or more other chloride salts.

3. The method of claim 2, wherein the one or more other chloride salts comprise at least a binary salt of UCl₃ and at least one additional chloride salt.

4. The method of claim 2, wherein the one or more other chloride salts comprise at least a ternary salt of UCl₃ and one additional chloride salt.

5. The method of claim 1, wherein the material is a used nuclear fuel salt comprising at least one fission product of uranium.

6. The method of claim 1, wherein the material is contained within a vessel during the maintaining, chlorinating, and collecting steps.

7. The method of claim 6, wherein the vessel is configured to act as a reactor core and is part of a nuclear reactor.

8. The method of claim 1, wherein the maintaining step holds the material at a temperature and pressure at which the material is molten and the different uranium chloride will boil.

9. The method of claim 8, wherein the temperature is between about 550° C. and about 900° C. and the pressure is about 1 atm.

10. The method of claim 9, wherein the temperature is about 600° C.

11. The method of claim 1, wherein the chlorinating step comprises exposing the material to chlorine gas.

12. The method of claim 1, wherein the chlorinating step comprises sparging chlorine gas and at least one of: a noble gas or an inert gas through the material.

13. The method of claim 1, wherein the chlorinating step comprises exposing the material to a combination of argon and chlorine gas.

14. The method of claim 1, wherein the chlorinating step comprises exposing the material to hydrochloric acid.

15. The method of claim 1, further comprising condensing the uranium-containing gas phase.

16. The method of claim 1, further comprising agitating the molten material.

17. A system, comprising:
a chlorination chamber configured to hold a molten material containing uranium trichloride (UCl₃), the chlorination chamber comprising:
a chlorination feature;
a uranium-containing gas phase outlet; and
a residue outlet; and
a condenser configured to receive the uranium-containing gas phase.

18. The system of claim 17, wherein the chlorination feature is configured to sparge chlorine gas through the mixture.

19. The system of claim 17, wherein the chlorination chamber is maintained at a temperature of between about 550° C. and about 900° C.

20. The system of claim 17, wherein the chlorination chamber is maintained at a temperature of about 600° C.

21. The system of claim 17, further comprising at least one fiber optical chemical sensor adjacent to the condenser.

22. The system of claim 17, further comprising at least one electrochemical instrument configured to monitor one or more electrochemical parameters within the chlorination chamber.

23. The system of claim 17, wherein material is a mixture of UCl₃ and one or more other chloride salts.

24. The system of claim 17, wherein the material is a used nuclear fuel salt containing fission products.

25. The system of claim 17, wherein the chlorination chamber is configured to act as a reactor core and is part of a nuclear reactor.
